(19) United States
(12) Patent Application Publication
(10) Pub. No.: US 2025/0050444 A1
(43) Pub. Date: Feb. 13, 2025

(54) ADAPTER MODULE FOR TORCH

(71) Applicant: The ESAB Group, Inc., North Bethesda, MD (US)

(72) Inventors: Michael Nadler, Wilmot, NH (US); Doug Smith, Florence, SC (US); Roger Chamberlin, Sunapee, NH (US); Yong Yang, Hanover, NH (US)

(21) Appl. No.: 18/446,921

(22) Filed: Aug. 9, 2023

(51) Int. Cl. B23K 9/32

(52) U.S. Cl. CPC B23K 9/323

(57) ABSTRACT

An adapter module for a torch includes a memory storing instructions thereon and one or more processors configured to execute the instructions stored on the memory to receive a first signal output by the torch and output a second signal based on the first signal to a power supply to operate the power supply.

### TECHNICAL FIELD

The present disclosure is directed toward welding and/or cutting torches and, in particular, to an adapter module configured to couple a torch and a power supply to one another.

### BACKGROUND

An arc processing torch, such as a cutting torch or a welding torch, is used to perform various operations with respect to a metal workpiece. For example, the torch may be used to remove material from the metal workpiece for a cutting operation or to melt material during a welding operation. The torch is generally configured to couple to a power supply so that the power supply can provide electric power and/or direct fluid to the torch. Then, the torch utilizes electric power and fluid to perform the cutting operation or the welding operation, such as by generating and sustaining a plasma arc. Unfortunately, certain embodiments of torches may not be able to couple or operate with certain embodiments of power supplies. In other words, a power supply may be compatible with some torches and not others. For this reason, the flexibility to use different torches may be limited by compatibility with an available power supply.

### SUMMARY

The present disclosure is directed towards an adapter module for a torch. According to one embodiment, the adapter module includes a memory storing instructions thereon and one or more processors configured to execute the instructions stored on the memory to receive a first signal output by the torch and output a second signal based on the first signal to a power supply to operate the power supply. Additionally or alternatively, the adapter module presented herein may include a first interface configured to couple to the torch, a second interface configured to couple to a power supply, and circuitry configured to output a signal to the power supply to operate the power supply.

Other systems, methods, features and advantages will be, or will become, apparent to one with skill in the art upon examination of the following figures and detailed description. All such additional systems, methods, features and advantages are included within this description, are within the scope of the claimed subject matter.

### BRIEF DESCRIPTION OF THE DRAWINGS

The techniques presented herein may be better understood with reference to the following drawings and description. It should be understood that some elements in the figures may not necessarily be to scale and that emphasis has been placed upon illustrating the principles disclosed herein. In the figures, like-referenced numerals designate corresponding parts/steps throughout the different views.

FIG. 1A illustrates a perspective view of an embodiment of a torch system including a power supply, a torch assembly, and an adapter module configured to couple the power supply and the torch assembly to one another, according to an example of the present disclosure.

FIG. 1B illustrates a perspective view of the torch system of FIG. 1A in which the adapter module is coupled to the power supply and to the torch assembly.

FIG. 2 illustrates a schematic diagram of the adapter module of FIGS. 1A and 1B, according to an example embodiment.

FIG. 3 illustrates a front view of an interface of the adapter module of FIG. 2, according to an example embodiment.

FIG. 4 illustrates a detailed view of internal components of the adapter module interface of FIG. 3, according to an example embodiment.

FIG. 5 illustrates a front view of another interface of the adapter module of FIG. 2, according to an example embodiment.

FIG. 6 illustrates a flowchart of a method for operating a torch, according to an example embodiment.

FIG. 7 illustrates a flowchart of another method for operating a torch, according to an example embodiment.

### DETAILED DESCRIPTION

The present disclosure is directed to techniques for a torch system that includes a torch and a power supply configured to enable operation of the torch, for example, by providing electric power and/or a fluid flow to the torch. The torch may use the electric power and the fluid flow to generate and maintain an arc to perform an operation, such as a cutting or welding operation. For example, the fluid includes a gas (e.g., a plasma gas, a working gas) used to initiate the arc. The fluid may additionally or alternatively include a coolant (e.g., water, another liquid) used to limit a temperature increase of the torch. In some embodiments, the torch is configured to operate in accordance with certain operating setting, such as a certain power level of electric power and/or a fluid flow of a certain pressure (e.g., for different types of operations). Thus, the power supply may operate in accordance with the operational settings to enable the torch to operate desirably.

Certain torches (e.g., a certain embodiment of a torch, a certain type of torch, a torch provided by a certain manufacturer) may be compatible with a particular power supply. For example, a torch, such as a smart or advanced torch, may be configured to provide a signal to a power supply based on a desirable implementation of a consumable with which the torch will operate. Some power supplies, such as a smart or advanced power supply, may be configured to process the signal to determine the desirable implementation of the consumable and can then direct electric power and/or fluid to the torch at specific parameters to initiate operation of the torch at suitable/proper settings.

However, another power supply, such as a simple or basic power supply, may not be configured to process the signal output by the torch and therefore may not be able to initiate desirable operation of the torch (e.g., at desirable operating settings for the torch). In fact, in some instances, a simple or basic power supply may not be compatible with a smart torch and, thus, may not enable operation of the torch at all. For example, if the smart torch includes a parts-in-place signal in/with a signal that a power supply cannot process, the smart torch may not be usable with that power supply. Alternatively, some power supplies may be configured to process a specific signal to initiate operations, but the torch may not be configured to output such a signal. Still further, in some instances, a torch might include a connector that cannot be mechanically connected to a port on a power supply, e.g., if the connector and port include different arrangements.

In view of the foregoing, many power supplies are compatible with a limited selection of torches, and vice versa. For this reason, a flexibility to use various combinations of torches and power supplies may be limited. For instance, a new power supply may have to be purchased to enable usage of a certain torch, thereby increasing costs of producing and/or obtaining equipment. Therefore, it is desirable to enable different torches and power supplies to operate with one another to provide greater flexibility to operate a torch system. Thus, embodiments of the present disclosure are directed to an adapter module configured to couple to a torch and to a power supply to enable the power supply to operate the torch.

For example, the adapter module presented herein may be configured to output a signal in accordance with communication protocols executed by the power supply to enable the power supply to process the signal and operate the torch, such as by providing electric power and/or fluid to the torch. In some embodiments, the adapter module is configured to receive an input signal provided by the torch for operating the torch, process the input signal to provide an output signal, and transmit the output signal to the power supply. The power supply may then operate the torch based on the output signal. As such, the adapter module enables the power supply to operate the torch, even though the power supply may not be able to process the input signal originally provided by the torch. Moreover, in certain embodiments, the adapter module is configured to determine an operational setting for the torch, and the signal output by the adapter module causes the power supply to operate the torch according to the operational setting. In this manner, the adapter module may enable the power supply to operate a torch more desirably (e.g., by automatically setting the proper operating parameters).

The adapter module may also include various interfaces to enable a torch to be physically coupled to one or more power supplies. For instance, the adapter module may include a first interface configured to physically couple to the torch (e.g., to a port/connector of the torch) and a second interface configured to physically couple to the power supply (e.g., to a port of the power supply). The interfaces therefore enable the adapter module to physically couple the torch and the power supply to one another, even though the torch may not be able to directly attach to the power supply. As such, the adapter module may enable a single torch to be interchangeably usable with different power supplies (e.g., power supplies that are otherwise not directly compatible with the torch) and/or to enable different torches to be interchangeably usable with a single power supply (e.g., a power supply that is otherwise not directly compatible with the different torches). In this way, the adapter module increases the flexibility and capability to use different torches and power supplies with one another.

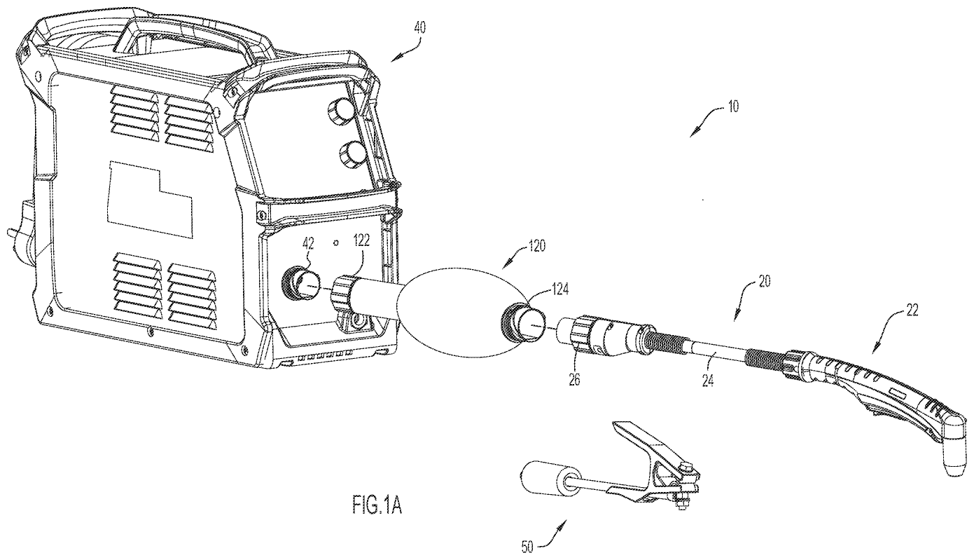

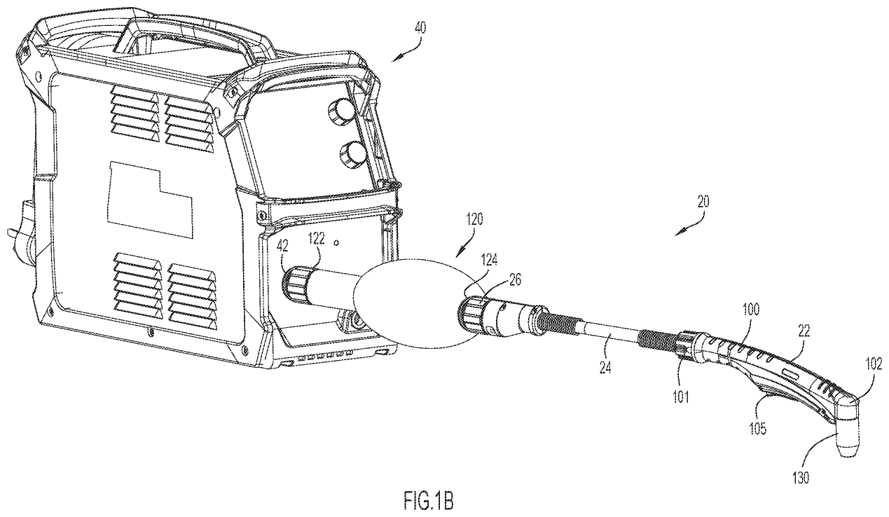

FIG. 1A illustrates an example embodiment of a torch system 10 (i.e., a cutting or welding system). While FIG. 1A illustrates the torch system 10 as a manual cutting system, it should be noted that the techniques discussed herein may be implemented in any other suitable torch system, such as an automatic cutting system, a manual welding system, an automatic welding system, and the like. The torch system 10 includes a power supply 40 and a torch assembly 20. The power supply 40 is configured to supply (or at least control the supply of) electric power and fluid. For example, the power supply 40 may include a discharge port 42 through which electric power and fluid may flow to the torch assembly 20.

The torch assembly 20 includes a torch 22 and a lead 24 (e.g., a torch lead). The lead 24 is configured to receive electric power and fluid from the power supply 40 and direct the received electric power and fluid to the torch 22. For instance, the lead 24 includes an inlet port 26 (e.g., a connector) through which electric power and fluid may flow. The supply of electric power and fluid to the torch body 22 may initiate operation of the torch assembly 20 to generate an arc, e.g., for generating a stream of plasma or transferring current to a welding wire. The illustrated torch system 10 also includes a clamp 50 (e.g., a grounding clamp) configured to secure to a metal workpiece to complete an electrical circuit for the torch system 10.

The illustrated torch assembly 20 may not be directly compatible with the power supply 40. As an example, the torch assembly 20 and the power supply 40 may not be able to physically couple directly to one another. For instance, the inlet port 26 of the torch assembly 20 may not be able to secure directly to the discharge port 42 of the power supply 40. Thus, the ports 26, 42 may not readily enable electric power and/or fluid flow between the power supply 40 and the torch assembly 20. As another example, the torch assembly 20 and the power supply 40 may not be able to communicate with one another (regardless of whether the two may physically connect). More specifically, in at least one implementation, the torch assembly 20 may be configured to provide an input signal for initiating operation of the torch assembly 20. By way of example, the torch assembly 20 may be configured to determine whether a consumable and its component parts are properly attached to the torch 22 using a position sensor, an optical sensor, or any other suitable sensor. Then, the torch assembly 20 may be configured to transmit the input signal (e.g., a sensor signal) in response to determining the consumable component parts are properly attached to the torch 22. The input signal transmitted by the torch assembly 20 may cause a certain embodiment (or embodiments) of a power supply to initiate electric power and fluid flow to the torch assembly 20, such as in a manner to enable desirable operation of the torch assembly 20 at a particular operational setting. However, other power supply embodiments, such as the power supply 40, may not be able to process such an input signal and therefore may not readily direct electric power and fluid and/or may not direct electric power and fluid at desirable settings to the torch assembly 20 based on the input signal.

Additionally or alternatively, the power supply 40 may require a particular signal (e.g., a parts-in-place (PIP) signal, a parts-in-contact (PIC) signal) in order to direct electric power and fluid toward a torch assembly. If torch assembly 20 cannot produce this signal in a manner that the power supply 40 can understand/process, then the torch 20 cannot sufficiently communicate with the power supply 40 to commence an arc processing operation. This is because industry standards may force the power source to receive PIP and PIC confirmations before sending power, e.g., for safety reasons. Additionally or alternatively, the torch assembly 20 might not be configured to transmit any other such signal that would enable the power supply 40 to direct electric power and fluid toward the torch assembly 20. In any of these cases, the power supply 40 may not readily enable operation, or at least desirable operation, of the torch assembly 20.

For this reason, the torch system 10 includes an adapter module 120 to enable coupling (e.g., physical coupling, electrical coupling, communicatively coupling) of the torch assembly 20 to the power supply 40. By way of example, the adapter module 120 includes a first interface 122 configured to couple to the discharge port 42 of the power supply 40, and a second interface 124 configured to couple to the inlet port 26 (e.g., the connector) of the torch assembly 20. The adapter module 120 is configured to provide signals that enable the power supply 40 to direct electric power and fluid to the torch assembly 20 to enable the torch assembly 20 to operate desirably. For instance, the adapter module 120 is configured to receive a signal provided by the torch assembly 20 (e.g., a signal that cannot be readily processed by the power supply 40), convert the signal into a converted signal that can be processed by the power supply 40, and direct the converted signal to the power supply 40 to cause the power supply 40 to direct electric power and fluid to the torch assembly 20 (e.g., in a manner to operate the torch assembly 20 at desirable settings) based on the converted signal. Additionally or alternatively, the adapter module 120 is configured to forward signals (e.g., without processing/converting the signals) received from the torch assembly 20 and/or from the power supply 40, such as a combination of a torch assembly 20 and a power supply 40 that are otherwise unable to communicate with one another (e.g., the torch assembly 20 and the power supply 40 do not include corresponding connection parts). For instance, the adapter module 120 may receive the input signal from the torch assembly 20 and directly transmit the input signal to the power supply 40 to enable the power supply 40 to direct electric power and fluid to the torch assembly 20. In either case, the adapter module 120 enables the power supply 40 to desirably operate the torch assembly 20 even though the power supply 40 and the torch assembly 20 may not be compatible with one another.

FIG. 1B illustrates a perspective view of the torch system 10 in which the adapter module 120 is coupled to the power supply 40 and to the torch assembly 20. To achieve this, the first interface 122 of the adapter module 120 is inserted into the discharge port 42 to couple the adapter module 120 to the power supply 40. Additionally, the inlet port 26 of the lead 24 of the torch assembly 20 is inserted into the second interface 124 of the adapter module 120 to couple the adapter module 120 to the torch assembly 20. Such coupling of the adapter module 120 to the torch assembly 20 and to the power supply 40 enables electric power and fluid to flow from the power supply 40 to the torch assembly 20 to initiate and maintain operation of the torch assembly 20. By way of example, the first interface 122 of the adapter module 120 receives electric power and fluid flow via the discharge port 42 of the power supply 40, and the second interface 124 of the adapter module 120 directs the electric power and fluid flow to the lead 24 via the inlet port 26.

In the depicted embodiment, the torch 22 includes a torch body 100 that extends from a first end 101 (e.g., a connection end 101) to a second end 102 (e.g., an operating or operative end 102). The first end 101 is coupled to the lead 24, and the lead 24 is configured to direct the electric power and fluid flow from the inlet port 26 to the first end 101 of the torch body 100. A consumable 130 (e.g., a consumable assembly composed of multiple consumable component parts) is coupled to the second end 102 of the torch body 100. The torch 22 is configured to direct the electric power and fluid flow from the first end 101 to the consumable 130 coupled to the second end 102. For example, the torch body 100 may include a trigger 105, and actuation (e.g., manual actuation) of the trigger 105 may enable electric power and fluid flow into the consumable 130 to enable operation of the torch assembly 20, such as to generate an arc (e.g., in response to an actuation and release or in response to continued actuation). In some embodiments, the fluid flow includes a gas that is used to initiate or strike the arc and to direct the arc onto a workpiece. In additional or alternative embodiments, the arc includes a liquid, such as water, which is used to cool parts of the torch 22 (e.g., the consumable 130). Cooling of the torch 22 may help maintain a structural integrity of the torch, thereby increasing an operational efficiency and/or a useful lifespan of the torch 22.

In certain embodiments, the adapter module 120 may readily couple to the torch assembly 20 and/or to the power supply 40 to enable interconnectivity between the torch assembly 20 and the power supply 40. That is, the adapter module 120 may be configured to effectuate operation of the torch assembly 20 via the power supply 40 without implementing any additional modifications to the torch system 10. In additional or alternative embodiments, the torch assembly 20 and/or the power supply 40 may be modified (e.g., by incorporating different connectors, by using different wiring harnesses, by changing a PCB) to enable the adapter module 120 to effectuate operation of the torch assembly 20 via the power supply 40.

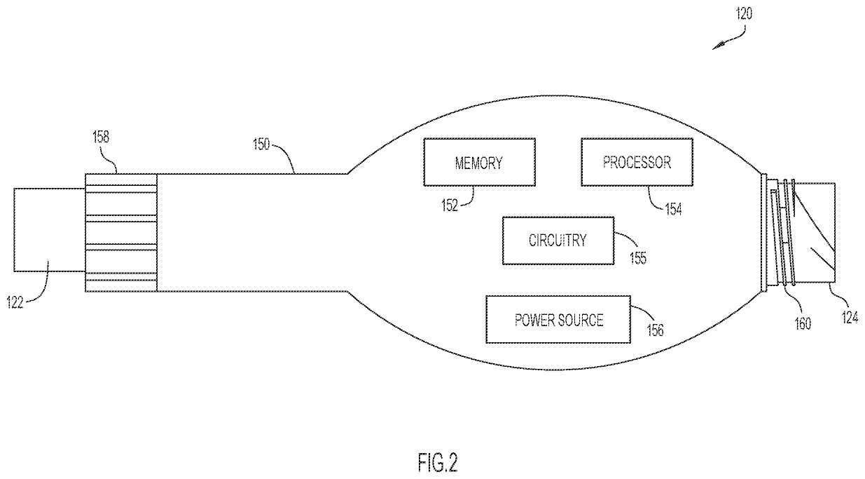

FIG. 2 illustrates a schematic diagram of the adapter module 120. The adapter module 120 includes a housing or enclosure 150 extending between the first interface 122 and the second interface 124. The housing 150 is configured to provide an interior passageway through which fluid provided by the power supply 40 may flow. That is, the housing 150 is configured to direct the fluid to the torch assembly 20 to enable operation of the torch assembly 20. However, in other embodiments, the housing 150 may include or define a tubular conduit through which fluid may flow through the housing 150. That is, in some embodiments, the housing 150 is a fluid conduit, whereas in additional or alternative embodiments, the housing 150 includes a separate fluid conduit extending therein. The housing 150 is also configured to enclose electrical components of the adapter module 120 to shield the electrical components from exterior elements, such as dust and/or debris. The housing 150 may also isolate the electrical components (e.g., via internal partitions or walls) from the fluid and power flowing through the housing 150 (physically and/or with electric shielding techniques). In this way, the housing 150 may protect the structure and operation of the electrical components included therein. The electrical components of the adapter module 120 are configured to communicate with the torch assembly 20 and/or with the power supply 40 to enable the power supply 40 to operate the torch assembly 20.

For example, the electrical components of the adapter module 120 may include a memory 152 and a processor 154 (e.g., processing circuitry). In some embodiments, the memory 152 and/or the processor 154 is a part of a printed circuit board (PCB) of the adapter module 120. The memory 152 includes read only memory (ROM), random access memory (RAM), magnetic disk storage media devices, optical storage media devices, flash memory devices, electrical, optical, or other physical/tangible (e.g., non-transitory) memory storage devices. Thus, in general, the memory 152 includes one or more computer-readable storage media (e.g., a memory device) encoded with software with computer executable instructions that may be executed to effectuate the operations described herein. For example, the memory 152 stores or is encoded with instructions that converts and/or generates a signal for operating the torch assembly 20 via the power supply 40. In some embodiments, the memory 152 stores data that indicates operational settings or parameters for the torch assembly 20, such as an electric power level and/or fluid flow rate, to enable desirable operation of the torch assembly 20 and/or of other torch assemblies. The processor 154 includes a collection of microcontrollers and/or microprocessors, for example, each configured to execute respective software instructions stored in the memory 152. The processor 154 is configured to, for example, execute the instructions stored in the memory 152 to communicate with the torch assembly 20 and/or power supply 40 and/or process inputs transmitted by the torch assembly 20 and/or power supply 40 (e.g., to generate and/or convert a signal for operating the torch assembly 20 via the power supply 40).

The adapter module 120 also includes additional circuitry 155 (e.g. disposed within the housing 150) configured to perform other suitable operations related to signal transmission and/or processing. For example, the circuitry 155 includes various electrical components, such as a conductor, a resistor, a transistor, a capacitor, an inductor, and so forth. The circuitry 155 enables communication between the memory 152 and the processor 154, as well as between the adapter module 120 (e.g., the processor 154) and the torch assembly 20 and/or the power supply 40. For instance, the circuitry 155 establishes a wired and/or wireless communication for signal transmission (e.g., to transmit a converted signal to the power supply 40).

In some embodiments, the memory 152, the processor 154, and/or the circuitry 155 are configured to operate using the electric power provided by the power supply 40. For example, a portion of the electric power received by the adapter module 120 from the power supply 40 is directed (e.g., away from the second interface 124) to the electrical components to enable operation of the memory 152, of the processor 154, and/or of the circuitry 155. Meanwhile, a remaining portion of the electric power received by the adapter module 120 is directed (e.g., to the second interface 124) to the torch assembly 20 to enable operation of the torch assembly 20. Any electrical schemes now known or developed hereafter may be utilized to achieve such powering and, regardless of the execution, the adapter module 120 may be able to operate without having to utilize an additional power source separate from the power supply 40.

In additional or alternative embodiments, the adapter module 120 includes a power source 156 (e.g., an auxiliary power source) configured to provide electric power to the memory 152, to the processor 154, and/or to the circuitry 155 to enable operation of the memory 152, of the processor 154, and/or of the circuitry 155. For example, the power source 156 may include a power storage (e.g., a battery, a capacitor) that may readily discharge power to the memory 152, to the processor 154, and/or to the circuitry 155. Such a battery may removable and/or rechargeable, e.g., including standard consumer batteries, such as AA or AAA batteries. Additionally or alternatively, the power source 156 may include a device configured to harvest energy (e.g., light, solar energy, kinetic energy) from a surrounding environment and produce electric power to be provided to the memory 152, to the processor 154, and/or to the circuitry 155. In further embodiments, the power source 156 may be configured to receive grid power, such as via an electrical outlet. In any of these embodiments, the memory 152, the processor 154, and/or the circuitry 155 may operate via the electric power provided by the power source 156 regardless of whether the power supply 40 is directing electric power to the adapter module 120. This may be important because the power supply 40 may not readily deliver electric power to the adapter module 120 prior to a desired operation of the memory 152, of the processor 154, and/or of the circuitry 155 to deliver an appropriate signal to the power supply 40. Thus, the memory 152, the processor 154, and/or the circuitry 155 may not initially be able to operate using the electric power provided by the power supply.

Accordingly, in at least some embodiments, the power source 156 may initially provide electric power to the memory 152, to the processor 154, and/or to the circuitry 155 to enable the memory 152, the processor 154, and/or the circuitry 155 to operate to transmit the appropriate signal to the power supply 40 and enable the power supply 40 to direct electric power to the torch assembly 20. In some instances, after an initial signal transmission to the power supply 40, operation of the memory 152, of the processor 154, and/or of the circuitry 155 may be maintained via the electric power directed by the power supply 40. That is, electric power provided by the power source 156 may be used to initiate operation of the memory 152, of the processor 154, and/or of the circuitry 155 to communicate with the power supply 40 to direct electric power, and the electric power provided by the power supply 40 may be used to maintain operation of the memory 152, of the processor 154, and/or of the circuitry 155 to communicate with the power supply 40. Put yet another way, the memory 152, the processor 154, and/or the circuitry 155 may operate via electric power provided by the power source 156 while electric power is not provided by the power supply 40 to the adapter module 120, and the memory 152, the processor 154, and/or the circuitry 155 may operate via electric power provided by the power supply 40 while the power supply 40 directs power to the adapter module 120. However, in other embodiments, other techniques may be used to temporarily power or support the memory 152, processor 154, and/or the circuitry 155 and/or to allow the aforementioned operations (e.g., siphoning power from the torch assembly 20, storing data/signals, etc.).

Further still, in certain embodiments, the adapter module 120 may not include the memory 152 and/or the processor 154. For example, as discussed, the adapter module 120 may be configured to forward signals, such as the input signal provided by the torch assembly 20 toward the power supply 40. In such embodiments, the adapter module 120 may communicatively couple the torch assembly 20 to the power supply 40 without the memory 152 and/or the processor 154. That is, the adapter module 120 may communicatively couple the torch assembly 20 and the power supply 40 to one another without having to process signals received from the torch assembly 20 and/or from the power supply 40. To this end, the adapter module 120 may use the circuitry 155 to transmit signals between the torch assembly 20 and the power supply 40, such as via a wired or wireless connection established by the circuitry 155.

The illustrated adapter module 120 is configured to couple to the power supply 40 and/or to the torch assembly 20 via threaded features. For example, the first interface 122 includes a threaded cap 158 (e.g., a threaded female socket) configured to receive a corresponding threaded portion of the power supply 40 (e.g., a threaded wall of the discharge port 42) to secure the adapter module 120 to the power supply 40. Furthermore, the second interface 124 includes a threaded insert 160 (e.g., a threaded male plug) configured to insert into a corresponding threaded portion of the torch assembly 20 (e.g., a threaded cap of the inlet port 26) to secure the adapter module 120 to the torch assembly 20. However, it should be noted that the adapter module 120 may be configured to couple to the power supply 40 and/or to the torch assembly 20 using any other suitable features.

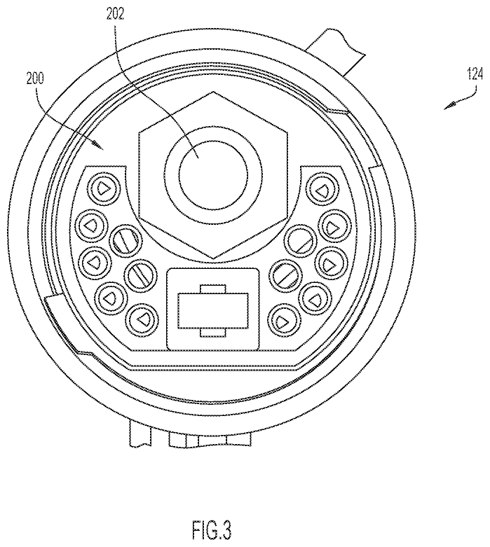

FIG. 3 illustrates a front view of the second interface 124 of the adapter module 120. The second interface 124 includes a first pin configuration 200 configured to couple (e.g., physically couple, electrically couple, communicatively couple) to a corresponding pin configuration of the torch assembly 20. Although the illustrated first pin configuration 200 includes ten pins, it should be noted that in additional or alternative embodiments, the first pin configuration 200 may include any suitable pin arrangement (e.g., having any suitable quantity of pins) to enable coupling with a corresponding pin configuration of a torch assembly. In some embodiments, the first pin configuration 200 is configured to receive a first signal from the torch assembly 20 for transmission of a second signal (e.g., a PIP signal, a PIC signal) to the power supply 40. For example, the torch assembly 20 is configured to transmit the first signal via its corresponding pin configuration, and the first pin configuration 200 is configured to receive the first signal transmitted by the torch assembly 20. In at least some embodiments, the torch assembly 20 is configured to transmit the first signal based on the consumable 130 being properly attached to the torch body 100. The first pin configuration 200 may be a part of or communicatively coupled to the processor 154 (e.g., the first pin configuration 200 may be a part of the circuitry 155), and the first pin configuration 200 may transmit the first signal to the processor 154 for processing of the first signal. By way of example, the processor 154 is configured to convert the transmitted first signal to the second signal or otherwise generate the second signal based on the first signal for transmission to the power supply 40 to cause the power supply 40 to direct electric power and fluid to the torch assembly 20.

In additional or alternative embodiments, the first pin configuration 200 is configured to transmit a third signal (e.g., a power signal based on electric power delivered by the power supply) to the torch assembly 20 to enable operation of the torch assembly 20. As an example, the third signal adjusts operation of the torch assembly 20 or components included in the torch and/or in close proximity thereto (e.g., electronically controlled valves), such as to enable or block fluid flow through the torch body 100 and/or the consumables 130 or otherwise adjust operation of the torch assembly 20 (e.g., an operational setting) based on operation of the power supply 40. Thus, the adapter module 120 is also configured to communicate with the torch assembly 20 to enable the torch assembly 20 to operate desirably. In such embodiments, a set of pins of the first pin configuration 200 may be used to receive a signal from the torch assembly 20, and another set of pins of the first pin configuration 200 may be used to transmit a signal to the torch assembly 20.

The second interface 124 also includes a first opening 202 that enables fluid flow therethrough. For instance, the first opening 202 is aligned with a passageway/conduit of the torch assembly 20 (e.g., of the inlet port 26) when the second interface 124 is coupled to the torch assembly 20, e.g., in an assembled configuration. Thus, the adapter module 120 is configured to direct fluid flow into the torch assembly 20 via the first opening 202.

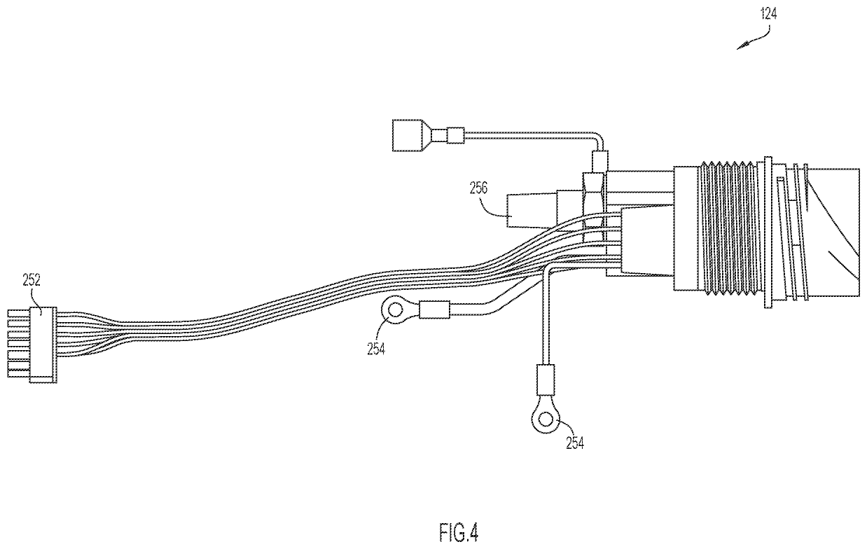

FIG. 4 illustrates a detailed view of the second interface 124 of the adapter module 120. Certain components of the adapter module 120 are not shown for visualization purposes. Various electrical connections (e.g., wires, cables) extend from the second interface 124, such as from the first pin configuration 200. As an example, communication connectors 252 (e.g., a part of the circuitry 155) are configured to propagate a signal (e.g., received from the torch assembly 20, for transmission to the torch assembly 20) between the adapter module 120 and the torch assembly 20, and ground connectors 254 (e.g., a part of the circuitry 155) are configured to provide an electrical connection to ground. The housing 150 is configured to enclose the communication connectors 252 and the ground connectors 254. In fact, in some instances, housing 150 may fluidly isolate the communication connectors 252 and the ground connectors 254 from a conductive fluid port 256 of the adapter module 120 (which may be connected to first opening 202) configured to direct fluid and electricity to the torch assembly 20.

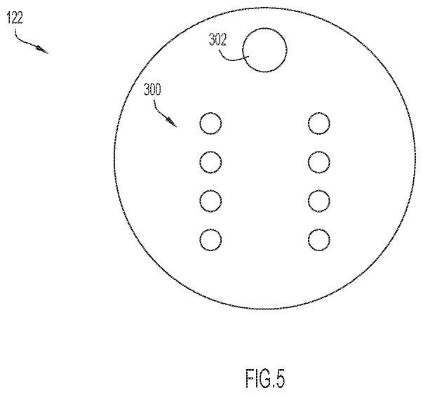

FIG. 5 is a front view of the first interface 122 of the adapter module 120. The first interface 122 includes a second pin configuration 300 (e.g., a part of the circuitry 155) configured to couple (e.g., physically couple, electrically couple, communicatively couple) to a corresponding pin configuration of the power supply 40. Although the illustrated second pin configuration 300 includes eight pins, it should be noted that in additional or alternative embodiments, the second pin configuration 300 may include any suitable pin arrangement (e.g., having any suitable quantity of pins) to enable coupling with a corresponding pin configuration of a power supply. Indeed, the first pin configuration 200 and the second pin configuration 300 may include a different quantity of pins and/or pins arranged in a different layout or pattern to couple to features of a torch assembly and of a power supply that may be unable to directly couple to one another. In some embodiments, the second pin configuration 300 is configured to transmit the second signal provided by the processor 154 to the power supply 40 based on the first signal received from the torch assembly 20 (e.g., via the first pin configuration 200). As an example, transmission of the second signal to the power supply 40 via the second pin configuration 300 enables the power supply 40 to direct electric power and fluid toward the torch assembly 20 to operate the torch assembly 20 in accordance with certain operational settings (e.g., indicated by the first signal provided by the torch assembly 20). In this way, the adapter module 120 is configured to receive the first signal via the first pin configuration 200 of the second interface 124, and the adapter module 120 is configured to transmit the second signal via the second pin configuration 300 of the first interface 122.

In additional or alternative embodiments, the second pin configuration 300 is configured to receive a signal (e.g., the third signal that adjusts operation of the torch assembly 20) from the power supply 40. That is, in addition to receiving a signal from the torch assembly 20 via the first pin configuration 200, the adapter module 120 may be configured to receive a signal from the power supply 40 via the second pin configuration 300. In at least some embodiments in which the torch assembly 20 is configured to transmit and receive signal(s) from the power supply 40 via the second pin configuration 300, a subset of pins of the second pin configuration 300 may be used to transmit the signal to the power supply 40, and another subset of pins of the second pin configuration 300 may be used to receive the signal from the power supply 40.

Still referring to FIG. 5, the first interface 122 includes a second opening 302 that enables fluid flow therethrough. As an example, the second opening 302 is fluidly coupled to the first opening 202. Thus, fluid may flow between the first opening 202 and the second opening 302 to flow between the power supply 40 and the torch assembly 20. Therefore, the adapter module 120 is configured to receive fluid flow from the power supply 40 via the second opening 302 and direct the fluid flow toward the first opening 202 to flow toward the torch assembly 20.

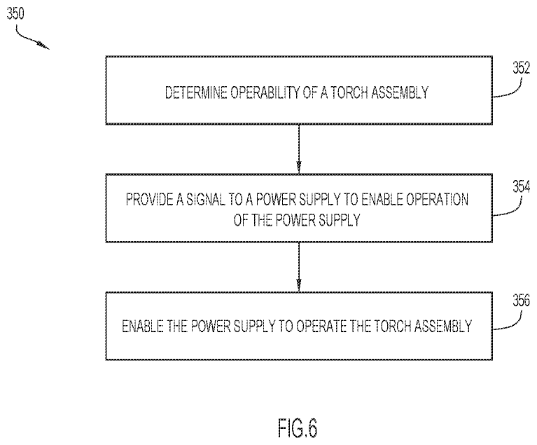

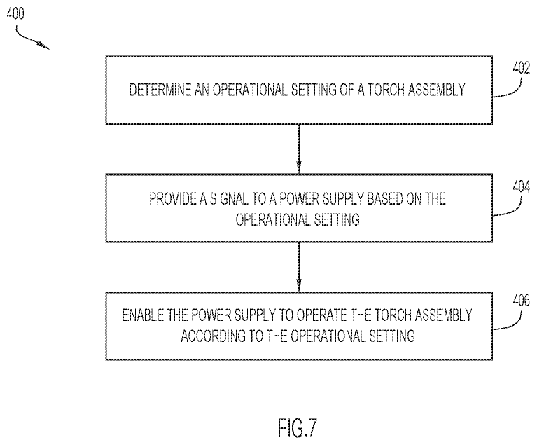

Each of FIGS. 6 and 7 described below illustrates an example method for operating the torch assembly 20. In some embodiments, operations of each method may be performed by a single component, such as the processor 154 of the adapter module 120. In additional or alternative embodiments, different operations of the methods may be performed by different components. It should also be noted that each method may be performed differently than depicted. For example, an additional operation may be performed, and/or a depicted operation may be removed, performed differently, and/or performed in a different order. Furthermore, the respective operations of each method may be performed in any suitable manner relative to one another, such as sequentially and/or concurrently.

FIG. 6 illustrates a flowchart of a method 350 for operating the torch assembly 20. At block 352, operability of the torch assembly 20 is determined. The operability may be indicated when an entire consumable assembly or a single consumable 130 (or, in the case of a cartridge, both) is properly coupled to a torch body 100. That is, in some embodiments, the torch assembly 20 transmits a signal to indicate the consumable 130 is properly coupled to the torch body 100 (e.g., in the proper location, secured correctly, etc.). The signal may be generated in response to actuation of a switch (mechanically or electrically), sensor feedback indicating that a coupling is secure and proper, and/or any other desirable techniques. In at least some embodiments, this signal comprises a PIP signal, a PIC signal, or both. The signal may also identify the consumable or consumable 130.

At block 354, a signal is provided to the power supply 40 to enable operation of the power supply 40 in response to determining that a consumable 130 has been properly secured to the torch assembly 20 (e.g., that the torch body 100 and the consumable 130 are coupled to one another). For example, the signal is transmitted in accordance with communication protocols executed by the power supply 40 to enable the power supply 40 to process the signal. The signal provided to the power supply 40 may be generated and/or converted based on the signal initially transmitted by the torch assembly 20.

At block 356, the power supply 40 is enabled to operate the torch assembly 20 upon receiving the signal. For example, the signal provided to the power supply 40 causes the power supply to provide electric power and/or fluid toward the torch assembly 20, and the torch assembly 20 utilizes the electric power and fluid to perform a processing operation, such as to initiate an arc.

Output of the signal to the power supply 40 may also be interrupted to suspend operation of the power supply. By way of example, the operability of the torch assembly 20 may be monitored. In response to a determination that the torch body 100 and the consumable 130 are no longer coupled to one another (e.g., based on an absence of the signal transmitted by the torch assembly 20), the output of the signal to the power supply 40 (e.g., at block 354) may be interrupted. Alternatively, a second signal may be sent to disable or override the initial signal from block 354. Either way, the power supply 40 may no longer provide electric power and/or fluid toward the torch assembly 20, and operation of the torch assembly 20 is suspended.

FIG. 7 illustrates a flowchart of a method 400 for operating the torch assembly 20, such as in response to determining the torch body 100 and the consumable 130 are coupled to one another. At block 402, an operational setting of the torch assembly 20 is determined. The operational setting may include a power level and/or a flow rate of fluid, for example, to enable suitable performance (e.g., cut or weld quality, cut or weld efficiency) of the torch assembly 20. The operational setting may be determined based on a type of the consumable 130 coupled to the torch body 100, an identification of the torch assembly 20 (e.g., installed components of the torch assembly 20), a type of processing operation to be performed by the torch assembly 20, user intent, an operational status, a structural integrity or wear condition of the torch assembly 20, and so forth. In some embodiments, the operational setting is determined based on the signal provided by the torch assembly 20, which, in turn, may be generated based on data gathered from the consumables, e.g., via sensors (e.g., optical sensors detecting markings on the consumables and/or acoustic sensors sensing acoustic properties of consumables), RFID tags, etc., In additional or alternative embodiments, the operational setting is determined based on a user input. For example, reference data that associates different operational settings to respective parameters may be used to select the corresponding operational setting.

At block 404, a signal is provided to the power supply 40 based on the operational setting. The signal is transmitted in accordance with communication protocols executed by the power supply 40 to enable the power supply 40 to process the signal, and the signal may be generated and/or converted based on the determined operational setting.

At block 406, the power supply 40 is enabled to operate the torch assembly 20 according to the operational setting. For example, the signal provided to the power supply 40 causes the power supply 40 to provide electric power and/or fluid to enable operation of the torch assembly 20 at the determined operational setting. In this manner, the signal provided to the power supply 40 may cause the torch assembly 20 to operate more suitably.

The operational setting of the torch assembly 20 may be monitored during operation of the torch assembly 20. For example, a determination may be made regarding whether the operational setting is to be maintained or changed during operation of the torch assembly 20. The signal may continue to be provided to the power supply in response to a determination that operation of the torch assembly according to the operational setting is to be maintained. The signal provided to the power supply may be adjusted in response to a determination that the torch assembly is to be operated according to an updated operational setting.

While the apparatuses and methods presented herein have been illustrated and described in detail and with reference to specific embodiments thereof, it is nevertheless not intended to be limited to the details shown, since it will be apparent that various modifications and structural changes may be made therein without departing from the scope of the disclosure and within the scope and range of equivalents of the claims. For example, the acoustic analysis apparatuses presented herein may be modified to contain any number of acoustical output generating devices, acoustical capturing devices, acoustic analysis computing devices, etc., and the acoustic analysis computing devices may connect to any number of input and output devices, along with any number of networks and/or servers. Additionally, the methods presented herein may be suitable for any type of welding and/or cutting consumables, including consumables utilized for automated (e.g., mechanized) and/or manual (e.g., handheld) operations.

In addition, various features from one of the embodiments may be incorporated into another of the embodiments. That is, it is believed that the disclosure set forth above encompasses multiple distinct implementations with independent utility. While each of these implementations has been disclosed in a preferred form, the specific embodiments thereof as disclosed and illustrated herein are not to be considered in a limiting sense as numerous variations are possible. The subject matter of the disclosure includes all novel and non-obvious combinations and subcombinations of the various elements, features, functions, and/or properties disclosed herein. Accordingly, it is appropriate that the appended claims be construed broadly and in a manner consistent with the scope of the disclosure as set forth in the following claims.

It is also to be understood that terms such as “left,” “right,” “top,” “bottom,” “front,” “rear,” “side,” “height,” “length,” “width,” “upper,” “lower,” “interior,” “exterior,” “inner,” “outer” and the like as may be used herein, merely describe points of reference and do not limit the present disclosure to any particular orientation or configuration. Further, the term “exemplary” is used herein to describe an example or illustration. Any embodiment described herein as exemplary is not to be construed as a preferred or advantageous embodiment, but rather as one example or illustration of a possible embodiment of the disclosure. Additionally, it is also to be understood that the components of the apparatuses described herein, the consumables described herein, or portions thereof may be fabricated from any suitable material or combination of materials, such as plastic or metals (e.g., copper, bronze, hafnium, etc.), as well as derivatives thereof, and combinations thereof. In addition, it is further to be understood that the steps of the methods described herein may be performed in any order or in any suitable manner.

Finally, when used herein, the term “comprises” and its derivations (such as “comprising”, etc.) should not be understood in an excluding sense, that is, these terms should not be interpreted as excluding the possibility that what is described and defined may include further elements, steps, etc. Similarly, where any description recites “a” or “a first” element or the equivalent thereof, such disclosure should be understood to include incorporation of one or more such elements, neither requiring nor excluding two or more such elements. Meanwhile, when used herein, the term “approximately” and terms of its family (such as “approximate”, etc.) should be understood as indicating values very near to those which accompany the aforementioned term. That is to say, a deviation within reasonable limits from an exact value should be accepted, because a skilled person in the art will understand that such a deviation from the values indicated is inevitable due to measurement inaccuracies, etc. The same applies to the terms “about”, “around”, “generally”, and “substantially.”

In the following detailed description, reference is made to the accompanying figures which form a part hereof wherein like numerals designate like parts throughout, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the description herein. Alternate embodiments of the present disclosure and their equivalents may be devised without parting from the spirit or scope of the present disclosure. It should be noted that any discussion herein regarding “one embodiment”, “an embodiment”, “an exemplary embodiment”, and the like indicate that the embodiment described may include a particular feature, structure, or characteristic, and that such particular feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the particular features, structures, or characteristics of the given embodiments may be utilized in connection or combination with those of any other embodiment discussed herein.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

What is claimed is:

1. An adapter module for a torch, comprising:
a memory storing instructions thereon; and
one or more processors configured to execute the instructions stored on the memory to:
receive a first signal output by the torch; and
output a second signal based on the first signal to a power supply to operate the power supply.

2. The adapter module of claim 1, wherein the one or more processors are configured to execute the instructions stored on the memory to:
determine an operational setting associated with the torch based on the first signal; and
output the second signal to the power supply to operate the power supply according to the operational setting.

3. The adapter module of claim 1, wherein the one or more processors are configured to execute the instructions stored on the memory to:
determine a type of consumable installed in the torch based on the first signal; and
output the second signal to initiate operation of the power supply based on the type of consumable.

4. The adapter module of claim 1, wherein the one or more processors are configured to execute the instructions stored on the memory to output a third signal to the torch to allow the torch to operate with the power supply.

5. The adapter module of claim 1, comprising:
a first interface configured to couple to the torch; and
a second interface configured to couple to the power supply.

6. The adapter module of claim 5, wherein the first interface is a female socket, and the second interface is a male plug.

7. The adapter module of claim 5, wherein the first interface comprises a first pin configuration, the second interface comprises a second pin configuration, and the first pin configuration and the second pin configuration being different from one another.

8. The adapter module of claim 1, comprising a conduit configured to direct a fluid flow from the power supply to the torch.

9. The adapter module of claim 8, wherein the conduit comprises a housing that encloses the memory and the one or more processors.

10. An adapter module for a torch, comprising:
a first interface configured to couple to the torch;
a second interface configured to couple to a power supply; and
circuitry configured to output a signal to the power supply to operate the power supply.

11. The adapter module of claim 10, wherein the circuitry is configured to output the signal to the power supply to cause the power supply to direct a fluid flow toward the torch.

12. The adapter module of claim 11, wherein the fluid flow comprises a gas, a coolant, or both.

13. The adapter module of claim 10, comprising a power source configured to supply electric power to operate the circuitry.

14. The adapter module of claim 10, wherein the circuitry is configured to output the signal to the power supply to cause the power supply to direct electric power toward the torch.

15. The adapter module of claim 14, wherein the second interface is configured to receive the electric power from the power supply, and the first interface is configured to provide the electric power to the torch.

16. The adapter module of claim 15, wherein the circuitry is configured to utilize a portion of the electric power directed by the power supply to operate.

17. A welding or plasma system, comprising:
a power supply including a discharge port;
a torch including a lead with a connector; and
an adapter module, comprising:
a first interface configured to couple to the connector of the torch;
a second interface configured to couple to the discharge port of the power supply; and
one or more processors configured to output a signal to the power supply to operate the power supply.

18. The welding or plasma system of claim 17, wherein the one or more processors of the adapter module are configured to:
receive an initial signal transmitted from the torch, the initial signal indicating an operability of the torch; and
output the signal to the power supply in response to receiving the initial signal from the torch.

19. The welding or plasma system of claim 18, wherein the one or more processors of the adapter module are configured to interrupt output of the second signal to the power supply to suspend operation of the power supply in response to an absence of the initial signal transmitted from the torch.

20. The welding or plasma system of claim 18, wherein the one or more processors of the adapter module are configured to:
determine an identification of the torch based on the first signal;
determine an operational setting based on the identification of the torch; and
output the signal to the power supply based on the operational setting.
